(19) United States
(12) Patent Application Publication
(10) Pub. No.: US 2002/0026459 A1
(43) Pub. Date: Feb. 28, 2002

(54) Method and system to produce customizable information guides based on individual customer preferences

(76) Inventor: Sergio Fernandez, Boise, ID (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/896,274

(22) Filed: Jun. 29, 2001

Related U.S. Application Data
(60) Provisional application No. 60/215,219, filed on Jun. 30, 2000.
(60) Provisional application No. 60/278,933, filed on Mar. 26, 2001.

(51) Int. Cl. G06F 17/00

(52) U.S. Cl. 707/506; 707/507

(57) ABSTRACT

The present invention is used to create customized information guides. One aspect of the invention includes a questionnaire used by information-recipients to describe their preferences. User preferences along with available information about a specific location are used to automatically create a personalized information guide. By presenting the user with a questionnaire, the task of acquiring information about the services available from a specific location is greatly simplified.

### RELATED APPLICATIONS

This application claims priority to and incorporates by reference, in its entirety, U.S. Provisional Application No. 60/215,219, titled, “METHOD AND SYSTEM TO COLLABORATIVELY PRODUCE MASSIVELY CUSTOMIZABLE INTERNET CONTENT BASED ON INDIVIDUAL CUSTOMER PREFERENCES”, filed Jun. 30, 2000, and U.S. Provisional Application No. 60/278,933, titled, “METHOD AND SYSTEM TO PRODUCE CUSTOMIZABLE INFORMATION GUIDES BASED ON INDIVIDUAL CUSTOMER PREFERENCES”, filed Mar. 26, 2001.

### BACKGROUND OF THE INVENTION

1. Field of the Invention

The present invention relates to a method and system for creating customized information guides and more particularly, using various interfaces to complete a questionnaire to generate a preference profile used in creating customized information guides.

2. Description of the Related Technology

Most travelers are familiar with the racks of brochures displayed in hotels and with tour guides. These brochures provide information about various activities, attractions and restaurants that a person can visit. However, a person can be inundated with the barrage of advertisements of which the traveler may have little or no interest.

Similarly, information about an attraction or activity can be also obtained from the Internet. This, too, can be complicated and time consuming for a traveler trying to obtain specific information in the ever growing collection of advertisements. Also, the traveler must have access to the Internet, which often is not convenient away from home.

What is needed is a method and system to weed out the unwanted advertisements and provide the traveler with a information guide that is customized for the particular interests of the traveler.

### SUMMARY OF CERTAIN INVENTIVE ASPECTS

The present invention describes a method and a system for the creation of customized information guides. Probing questions about a user's interests are organized in a questionnaire and used to develop a preference profile of the user. Each question has one or more answers. Each answer has one or more references associated with it. The references are used to create a customized information guide for a particular date about a specific location or subject. The geographical location of service providers and service hosts is recorded by the system and used to create a map with the location of the service hosts and the service providers included in the guide.

In addition to the creation of customized content, the present invention allows for enrollment of service hosts and service providers. Enrollment is used to manage content creation and organization. Every time that a customized information guide is generated, the transaction information is stored. Transaction information is used to generate reports and revenues. Users may also enroll in the system so that their answers are stored and used to automatically print customized guides in other locations.

One aspect of the invention comprises a system to collaboratively produce customized information guides. The system includes storing information content relating to a plurality of service providers and one or more service hosts, a way for inputting a set of user preferences, a way for relating the selected user preferences to ones of the information content, a way for storing layout information, a way for formatting the selected information content with the layout information in the form of a guide suitable for printing or viewing in diverse media, and a way for outputting the guide to an output device.

Another aspect of the invention comprises a method of retrieving service provider information that is associated with a service host, retrieving a plurality of user preferences, identifying a portion of the service provider information that relates to the user preferences, creating a custom electronic guide with the identified portion, and printing the custom electronic guide at the location of the service host.

Another aspect of the invention includes completing a questionnaire to obtain the user preferences. Completing the questionnaire can include: scanning the questionnaire into a computer, typing answers to the questionnaire into a computer, or entering information into a television. In another embodiment, the questionnaire is filled out when a user applies for a credit card. A database is maintained with these preferences and can be accessed using the credit card.

Yet another aspect of the invention comprises a user questionnaire module for obtaining user preferences, layout software that provides a format for an electronic guide, retrieval software for generating the content of the electronic guide that is based at least in part upon the user preferences and a format that is supplied by the layout software, and a print robot for printing the electronic guide.

Yet another aspect of the invention comprises enrolling a service host or a service provider. Service providers and service hosts that provide content select the active content to be retrieved by the reference from multiple versions using interactive systems, date constraints or other specifications. For example, a service provider may use a web-based interface to activate a promotion, may schedule certain coupons to be printed on specific days, or may schedule the cancellation of a promotion when it has been printed a selected number of times. Reports may be generated indicating the number of times a service provider or service host has been included in information guides.

Yet another aspect of the invention comprises a fax to scan user questionnaires, layout software that provides a format for an electronic guide, retrieval software for generating the content of the electronic guide that is based at least in part upon the user preferences and a format that is supplied by the layout software, and a print robot for printing the electronic guide that contains information about such products.

Yet in another aspect of the invention, the user preferences are specified by scanning the bar-code impressed in the products, and wherein the system includes: layout software that provides a format for an electronic guide, retrieval software for generating the content of the electronic guide that is based at least in part upon the user preferences and a format that is supplied by the layout software, and a print robot for printing the electronic guide that contains information about such products.

### BRIEF DESCRIPTION OF THE DRAWINGS

The features, objects and advantages of the present invention will become more apparent from the detailed description set forth below when taken in conjunction with the drawings in which like references characters identify correspondingly throughout, and wherein:

FIG. 1 is a flowchart illustrating how a customized information guide is created.

FIG. 2 is a flowchart illustrating a process of inputting a paper copy of a questionnaire into a service host.

FIG. 3 is a flowchart illustrating a process of inputting a questionnaire into a user computer.

FIG. 4 is a flowchart illustrating a process of inputting a questionnaire into a television set.

FIG. 5 is a flowchart illustrating a process of inputting a questionnaire using a bar code reader.

FIG. 6 is a flowchart illustrating a process of inputting a questionnaire using a credit card.

FIG. 7 is a block diagram of retrieval software.

FIG. 8 is a flowchart illustrating a process of enrolling a service host and how the transactions are stored when a customized information guide is generated in order to create service host reports.

FIG. 9 is a flowchart illustrating a process of enrolling a service provider and how transactions are stored when a customized information guide is generated in order to create service provider reports.

FIG. 10 illustrates the cover of an exemplary customized tour guide.

FIG. 11 illustrates the first page of the exemplary customized tour guide of FIG. 10.

FIG. 12 is a graphic interface for associating answers in the questionnaire with service provider information.

FIG. 13 is a graphic interface for uploading service provider information.

FIG. 14 is graphic interface for providing confirmation information.

FIG. 15 is a graphic interface for identifying the location where services are provided by a service provider.

### DETAILED DESCRIPTION OF CERTAIN INVENTIVE EMBODIMENTS

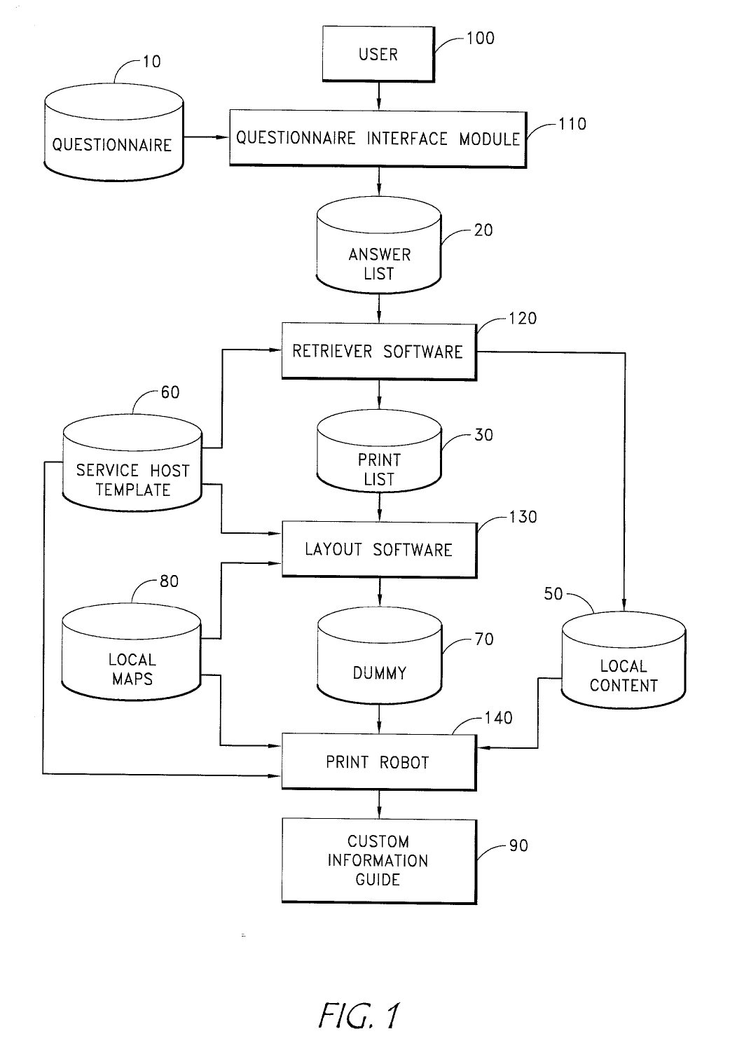

FIG. 1 illustrates one embodiment of a method to create a customized information guide 90. Information guides 90 are customized by using a preference profile of the user, and obtaining information about the service host, nearby service providers and other local information in areas of interest as indicated by the preference profile. A service host questionnaire 10 is generated that contains a series of questions. The questions have corresponding answers, and at least one reference to content is associated with each answer. The answers can be presented in multiple-choice format. Furthermore, answers can be gathered by scanning bar-codes of products, or printed card or services that a user may be interested in.

A questionnaire interface module 110 reads the service host questionnaire 10. To start the process, a user 100 interacts with the questionnaire interface module 110 to answer questions from the questionnaire 10. The questionnaire interface module 110 uses the answers to generate an answer list 20 of user preferences. The answer list 20 contains the answers selected by the user and the references associated with the selected answers as will be discussed below. The references contain information such as service host facilities, service provider information, and other general information.

In an example of one embodiment, service hosts such as hotels provide access to the questionnaire interface module 110. In this embodiment, hotel guests act as the users 100. Stores, parks, restaurants, and entertainment facilities are service providers. General information is information available from sources through a communications network, e.g. the Internet, such as weather information and movie reviews.

To support different interfaces, there are various versions of the question interface module 110. Embodiments of the invention support a pen-paper-scanner interface, a pen-paper-fax interface, a credit card reader interface, a web-based interface, a television remote-control interface, and a bar code reader, each of which will be discussed below. Further embodiments of the invention may add other interfaces to the system. For example, an interface with profiling companies, such as travel agencies, may be provided so that the answer list 20 of the user 100 can be automatically sent to a profiling company.

For example, when a user applies for a credit card, the credit card company includes a questionnaire and obtains the preference profile of the user. A database is maintained with these preferences. The preference profile stored in the database can then be used to automatically answer questionnaires when the user goes to other locations. When the user inserts the credit card into a credit card reader, the user preferences are automatically retrieves the preference profile and the information guide is rapidly completed using the preference profile.

A further embodiment of the invention provides an interface module for devices such as personal data assistants (PDA) or audio-text devices. The PDA interface module formats the questionnaire and downloads it to a PDA, a portable computing device or a communication device, e.g. a cellular telephone, and the questionnaire is answered on the device. The audio-text interface creates voice recordings of the questions and answers, or alternately, a mechanism to convert text to speech, and the user selects the answers by using telephone keys or speech-recognition software. Regardless of the version of the question interface module, the output of the module is an answer list 20 with the user-selected answers and associated references. Associated references can include links, hyperlinks, uniform resource locations (“URL”) and other pointers.

In a further embodiment of the invention, the answer lists 20 are stored and used at other locations to generate customized information guides 90 or to pre-select user preferences in interactive interfaces. Additionally, statistical information about the answers is used to pre-select user preferences of users with similar profiles in interactive interfaces or to automatically include information in the customized information guides of users with similar profiles.

The answer list 20 is received by retrieval software 120. The retrieval software 120 processes the references and retrieves, into a local content repository 50, the content addressed by the references. This content is used to produce the custom information guide 90. The retrieval software 120 ensures the content is current and in the appropriate format. The retrieval software 120 creates a print list 30. The print list 30 contains an entry for each reference and also contains the maps that are to be used in the information guide 90. Each entry specifies where in the local content repository 50 the content that is associated with a reference is located.

In one embodiment, the print list 30, the local maps 80 and a service host template 60 are used by layout software 130 to create a dummy 70 of the information guide 90. The service host template 60 contains information used to format every information guide 90 created and to format the questionnaires 10 for different user interface modules. The service host template 60 is also used to provide a consistent layout to each questionnaire interface module 110 and each information guide 90 created. Additionally, the service host template 60 may contain information used to customize the content for a particular service host. For example, the customized information guides printed by a hotel may include a cover page, and the interior pages may include a logo and additional information such as addresses and telephone numbers. In order to improve the presentation of the information guides, the Internet content may be formatted. In order to improve the presentation of the information provided by service providers, guidelines and templates may be used. Since every customized information guide is different, the printable content is automatically laid out using parameters defined in the service host template 60. The local maps 80 contain maps of the locations of service hosts and service providers.

The dummy information guide 70, the service host template 60, local maps 80, and the local content repository 50 are used by a print robot 140 to create the customized information guide 90. The print robot 140 reads the dummy 70, inserts the formatted service host and service providers content from the local content repository 50 in the spaces marked by the dummy 70, and positions numbers that specify the location of service providers on the maps provided by local maps 80 and in the service providers content.

The output of the print robot 140 is a printable information guide 90 that can be output to any suitable device. In a further embodiment of the invention, the print robot 140 formats the content of the customized information guide 90 so it can be downloaded to a PDA or to any other portable computing or communication device suitable for viewing the content.

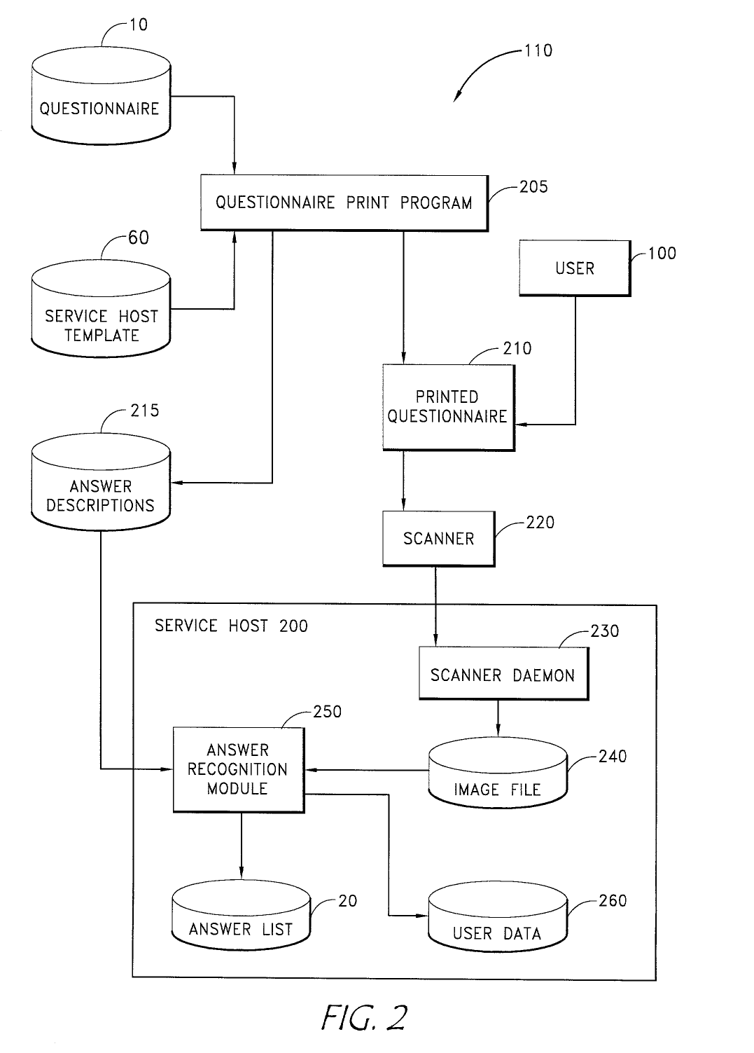

FIG. 2 shows one embodiment of the questionnaire interface module 110 based on a paper-pencil-scanner interface. A questionnaire-print-program 205 uses information in the questionnaire 10 and the service host template 60 to print a questionnaire 210. A single service host may print different questionnaires 210. For example, a first questionnaire 210 for families and a second, different questionnaire 210 for business travelers can be produced.

For each questionnaire 210 that is printed, the information that describes the printed questionnaire pages identification marks as well as the position of the answers that the user marks on that page, are stored in an answer description repository 215. The answers on the questionnaire 210 may be presented in multiple-choice format. The user 100 uses a pen or pencil to mark the answers. Additional areas can be provided for the user to hand-write information such as credit card number and name. Once the questionnaire 210 is answered, it is placed in a scanner 220 and the scan button is pressed. A scanner daemon program 230 that may run in the service host 200 or in any other PC starts when the scan button is pressed. The daemon program 230 scans the document and creates an image file 240. The image file 240 can be any known format for scanned files, such as JPEG or TIFF. After scanning the file, the daemon program 230 calls an answer recognition module 250. The answer recognition module 250 looks for questionnaire identification marks and compares them with the ones stored in the answer description repository 215. In addition to a scanner, a video camera, a fax machine or any other image gathering device may be used.

Once a questionnaire page is identified, the information about the position of the answers is used to determine whether the user marked an answer and to generate the answer list 20 (FIG. 1). In addition to the answer list 20, the answer recognition module 250 stores the areas of the printed questionnaire 210 that contain handwritten information and stores them in the user data repository 260. Handwritten information can later used by the print robot 140 to print the name of the user in the information guide 90 (FIG. 1). Furthermore, if the printed questionnaire 210 is used to enroll with a profiling company, the handwritten information may be sent to the profiling company. Examples of hand-written information include demographic data such as name, address, credit card information, signatures, etc.

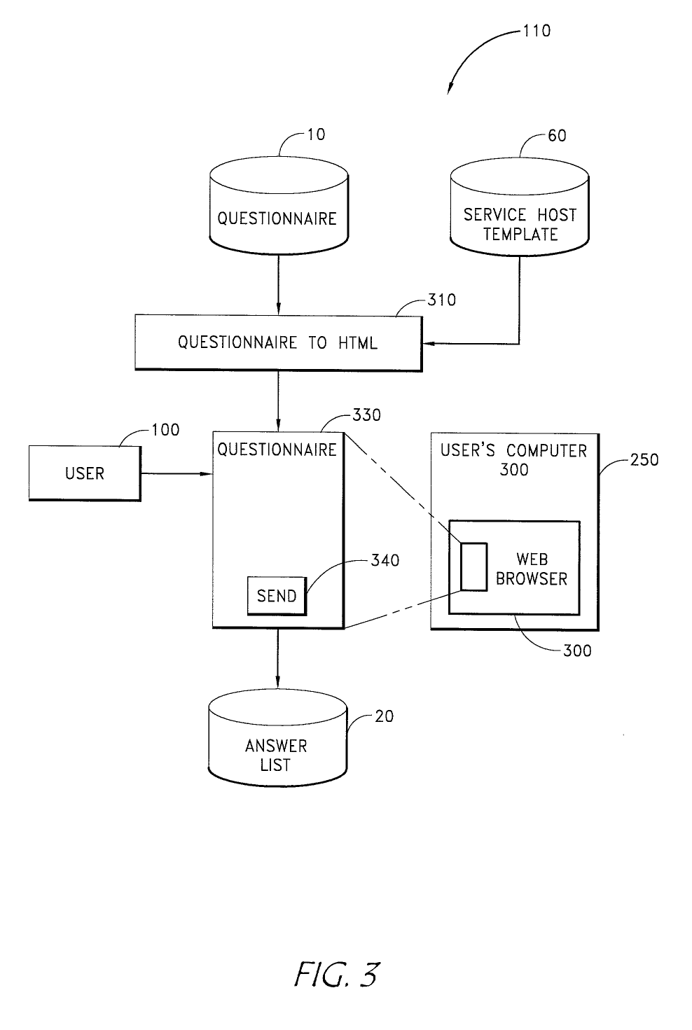

FIG. 3 shows one embodiment of the questionnaire interface module 110 based on a web interface. A questionnaire-to-HTML program 310 uses the questionnaire 10 and the service host template 60 to produce an HTML version of the questionnaire 330. The web browser 320 in the user's computer 300 displays the questionnaire 330. The user 100 interacts with the questionnaire 330 and presses the send button 340. When the send button is pressed, tags in the HTML questionnaire produce the answer list 20. Of course, HTML, SGML, XML are but ones of many ways to represent the information.

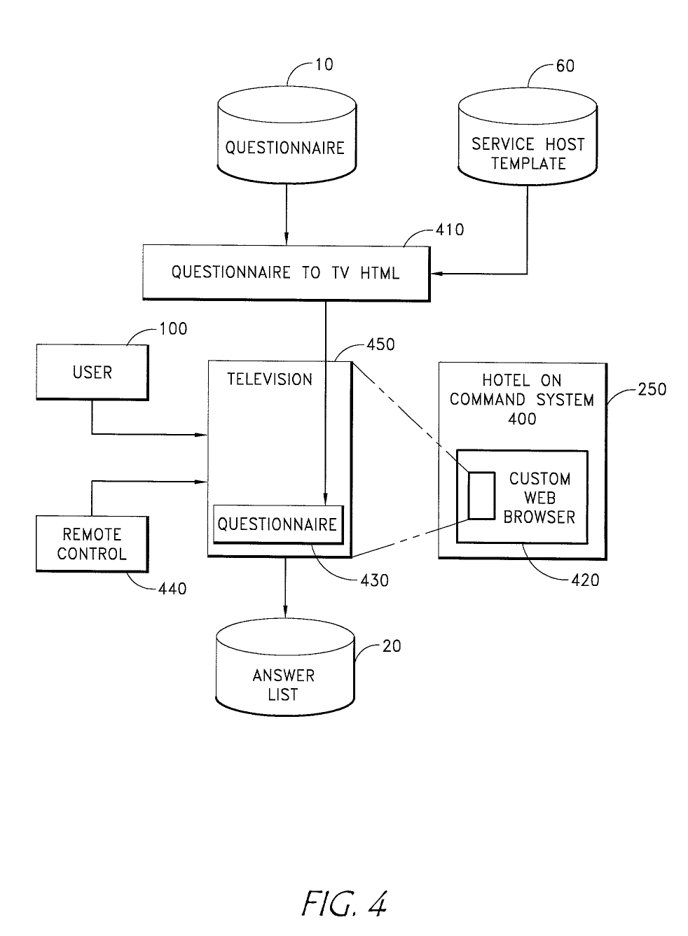

FIG. 4 shows one embodiment of the questionnaire interface module 110 based on a remote control 440 and a television 450 interface. A questionnaire-to-TV HTML program 410 uses the questionnaire 10 and the service host template 60 to produce a TV HTML version of the questionnaire 430, for example. The web browser 420 displays the questionnaire on the television screen 450. The user 100 interacts with the questionnaire 430 using the remote control 440. When the user is done, he or she presses the send button. When the send button is pressed, tags in the HTML questionnaire may be used to produce the answer list 20.

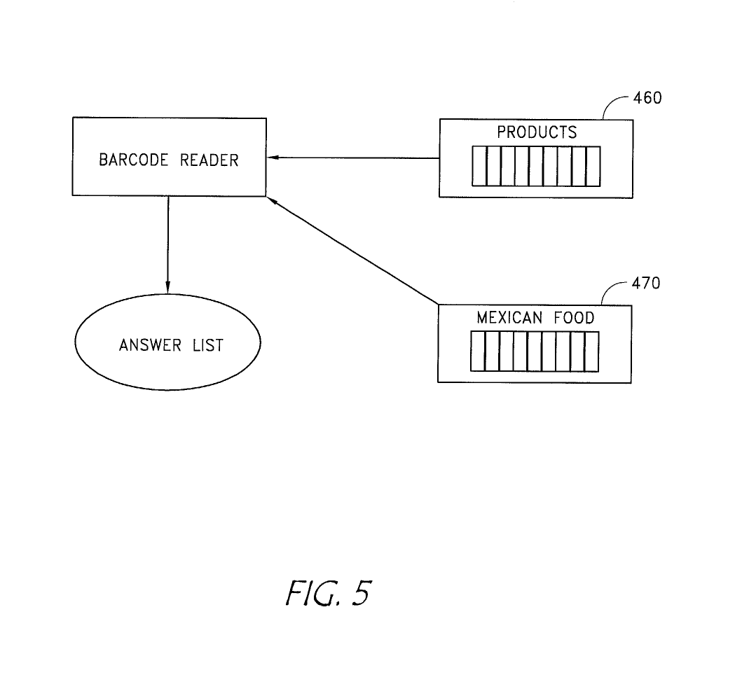

FIG. 5 shows one embodiment of the questionnaire interface module based on a bar-code reader. A user 100 selects the products or services by scanning bar codes 460 printed on the products or on cards with the services description 470. When the user is done scanning, the barcodes are used to create an answer list 20.

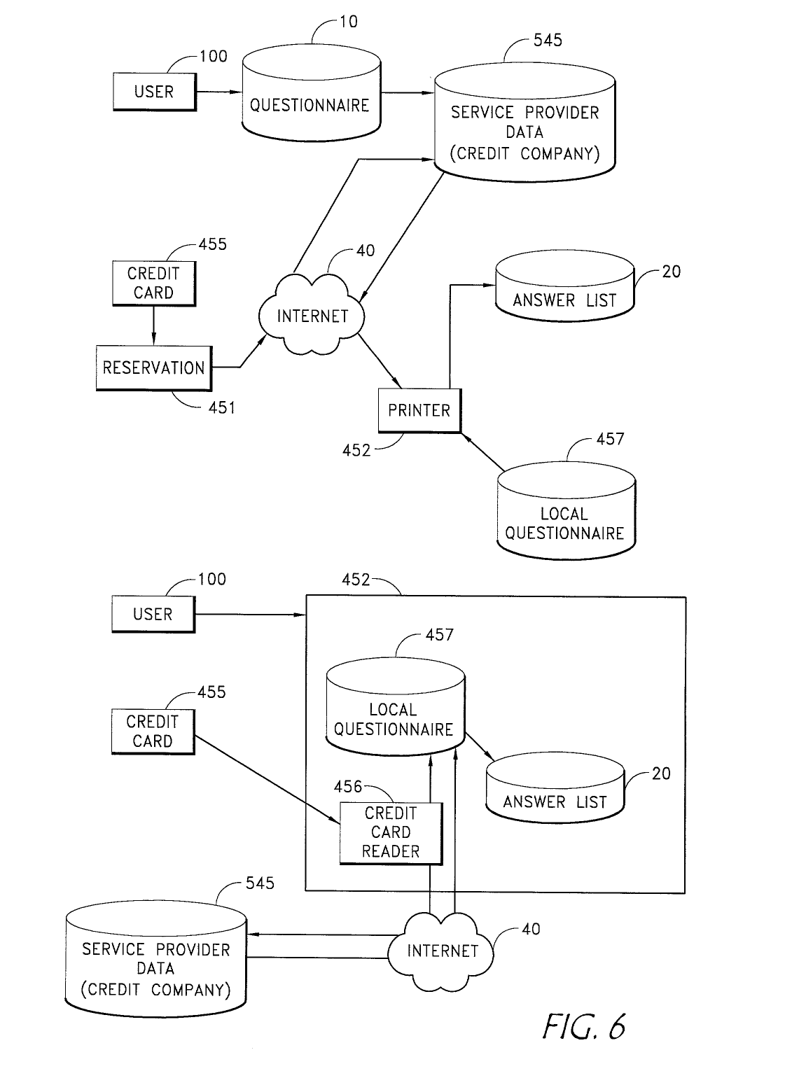

Referring to FIG. 6, when the user 100 applies for a credit card 455, he also completes a questionnaire 10 in order to obtain the user's profile information. The profile information is stored in a database 545. When the user 100 makes a reservation 451 using the credit card 455, the profile information is sent to a printer 452. When the user 100 arrives at the travel destination, the printer 452 uses the profile information together with a local questionnaire 457 to create the answer list 20 used to produce a custom information guide 90.

In another embodiment of the invention, a credit card reader 456 attached to the printer 452 may be used to obtain the credit card number. Using the number, the software will request the profile information from the credit card company and use that information to create the answer list 20 used to produce a custom information guide 90. In a further embodiment of the invention, the profile information is stored in the credit card 455 and it is retrieved by a credit card reader 456 and used together with the local questionnaire 457 to create the answer list 20 used to produce a custom information guide 90.

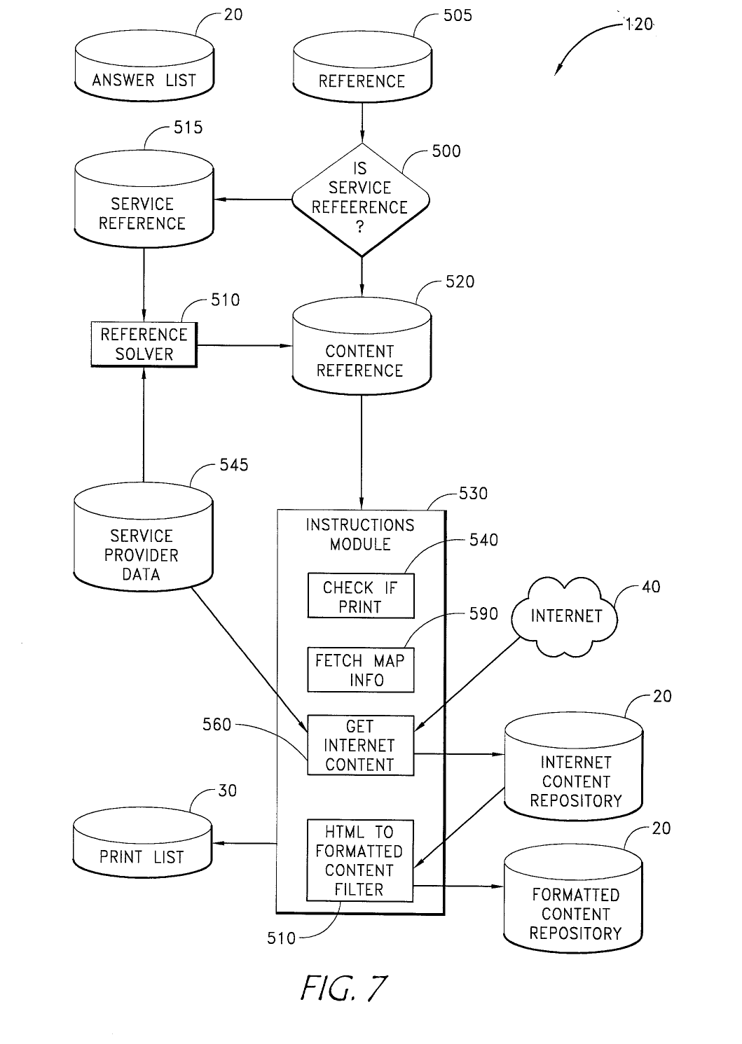

FIG. 7 shows one embodiment of a diagram of the retrieval software 120. The answer list 20 contains a plurality of references 505. The references 505 may be to service providers, service hosts, Internet content, or other general databases.

Retrieval software 120 first resolves if the reference 505 is to a service reference 515, which includes references to service hosts and service providers. If the reference 505 is a service reference 515, the reference 505 is sent to the reference resolver 510. Since service hosts and service providers are both content providers, they are treated the same way by the reference resolver 510. To resolve a reference 505 to a service provider, the local service provider data repository 545 is consulted to find the URL for the service-provider home machine. Using the service-provider home machine to solve the references will guarantee that the service provider instructions for content selection are followed. The local service-provider data repository 545 and the local content repository 50 are used as a back up in case that no connection can be established with the service-provider home machine.

The reference resolver 510 receives as input a reference to a service host or service provider and returns with a content reference 520 that, for example, contains the URL to find the content and the SGML instructions about the content.

The Special Instructions Module 530 interprets the SGML tags contained in content references. The check-if-print 540 module checks the SGML tags used to determine if content for a particular date and time should be printed.

Tags may be used to store the dates when the content should be printed. In addition tags may require a program to be called to implement more complex algorithms to determine if a content should be placed. An example of a complex algorithm would be to print a five-dollar coupon with the first one hundred information guides printed in a neighborhood every Monday.

By default all the content is validated to make sure that the version in the local content repository 50 is current. If the content is current, or if there is no connection to the machine that provided the content, the local version can be used, thus avoiding delays associated with transmission times. The local storage repository 50 is comprised of the Internet-content repository 555 and the formatted content repository 580. The local storage repository 50 is used as a back-up for the information and as a cache to speed the retrieval of information.

A fetch-map-info module 590 checks to see if geographical information about the service provider exists in the service provider repository 545. If there is geographical information, maps will be included in the print list 30. A get-internet-content module 560 retrieves Internet content and stores it in the local Internet content repository 555. If the SGML tags indicate that the Internet content should be formatted, an HTML-to-Formatted filter 570 will be called. Formatted content is stored in a formatted content repository 580. Additional SGML tags in the references to content may be used by the HTML-to-formatted filter 570 to store information that facilitates the conversion.

The SGML tags may indicate that a formatted version of the content was created by hand. In this case the tags may contain the email address of the operator that should be notified when the content is obsolete. If no SGML tags are present, the content from the Internet is printed as is.

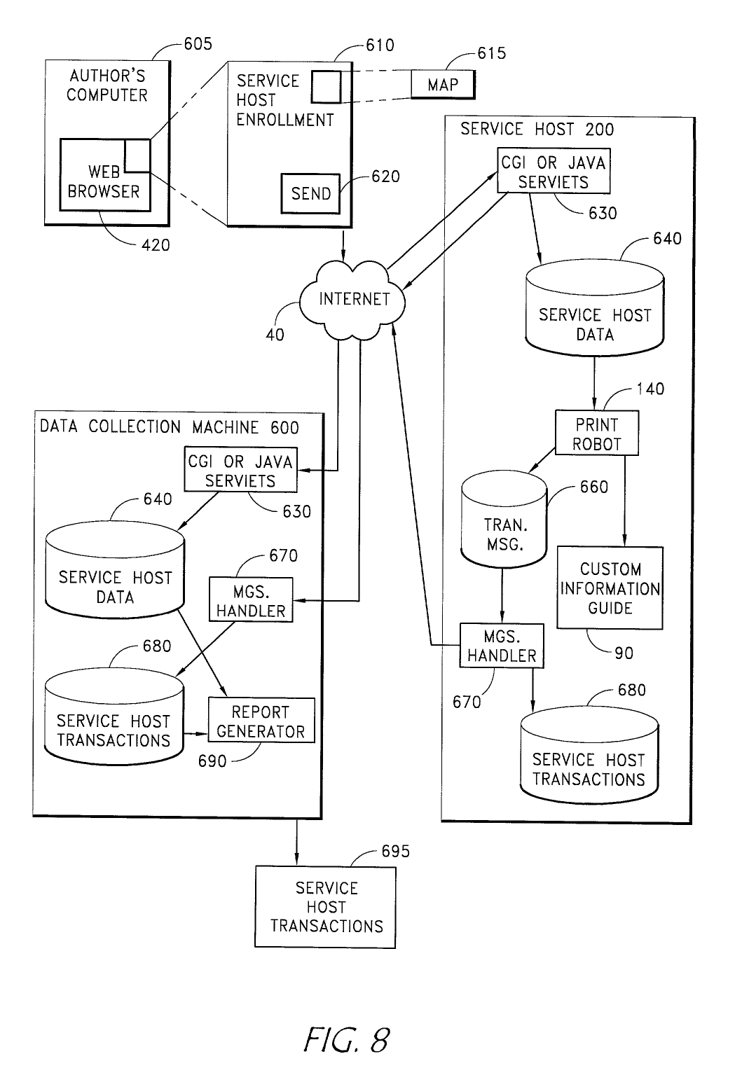

FIG. 8 describes one embodiment of the process of enrolling a service host and how the transactions are stored every time a customized information guide is generated in order to create service host reports 695. A web browser 420 in the author's computer 605 is used to access the enrollment form 610. The author enters general information (including the service host template to use) about the service host and specifies the machine that will be the data collection machine for this service host.

Dynamic maps 615 allow the author to indicate the location of the service host. Once the form is filled in, the form information is sent 620 to a program 630 in the service host machine 200. The program 630 stores the information in the service host data repository 640 and forwards the information to another instance of the program 630 running in the data collection machine 600 where the data is stored in the service hosts-data repository 640.

When the print robot 140 prints a customized information guide 90, a transaction message 660 is sent to a message handler 670. The message handler 670 stores the transaction in a service host transactions data repository 680 and forwards the message to the data collection machine where the process is repeated. The report generator 690 uses data from the service host-transactions data repository 680, the service host data 640 and the service host template (not shown in the figure) to generate service host reports 695. Forwarding the information to data collection machines (not shown) provides a back up of the information. Data collection machines may be configured to forward the information to other data collection machines, allowing the creation of a hierarchy of machines. Machines higher in a hierarchy contain information from machines lower in the hierarchy and can generate reports about the transactions in machines that are lower in the hierarchy. In addition, the message handler 670 provides an interface with other machines. Of course, smaller system a single machine may be configured to run in a single machine.

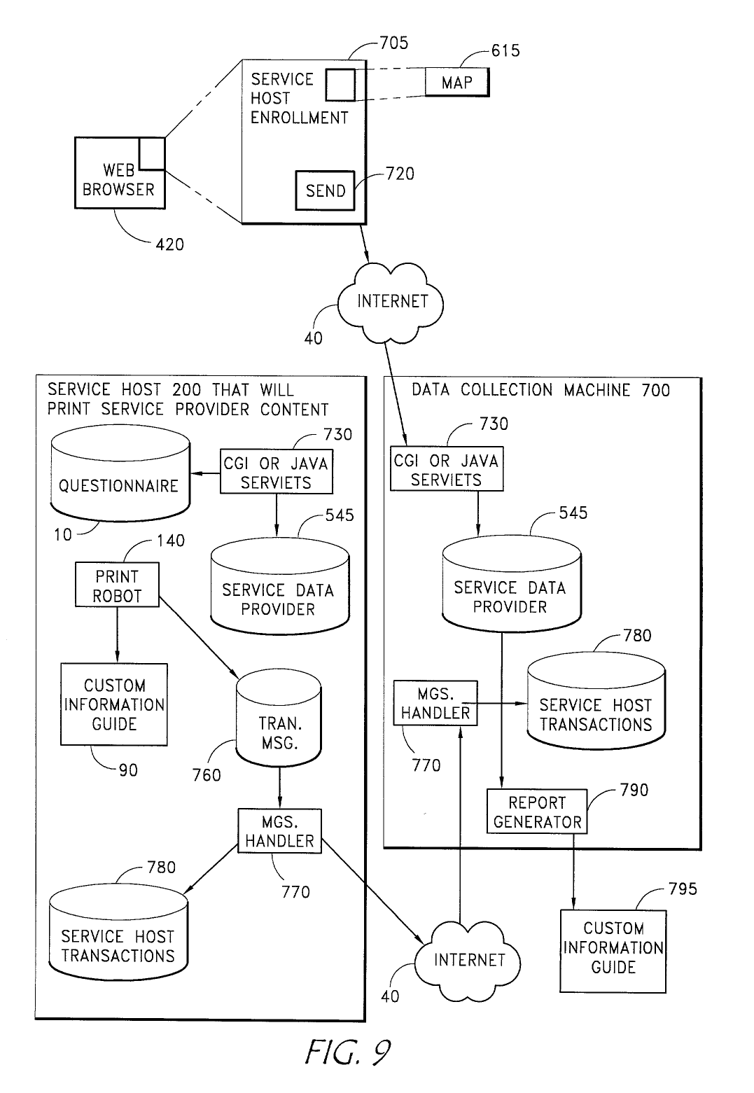

FIG. 9 describes one embodiment of the process of enrolling a service provider and how transactions are stored every time that a customized information guide 90 is generated in order to create service provider reports 795. A web browser 420 is used to show a service-provider enrollment form 705. The user enters general information about the service provider, including the machine that will act as its data collection machine 700. Dynamic maps 615 allow the user to indicate the location of the service-provider.

As part of the enrollment, the service provider can select one or more service hosts 200 where its content will be printed. To facilitate the selection, the information about the location of the service providers and the location of the service hosts close to the service-provider area is used.

Once the form is completed, the form information is sent 720 to a program 730 running in the service-provider data collection machine 700. The program stores the information in the service-provider data repository 545 and forwards the information to all the designated service host machines 200. In every service host-machine the program 730 stores the information in the service-provider data repository 545. Apart from updating the service provider data repository 545, the program 730 updates its local questionnaire 10 to add the service-provider reference in the appropriate answer.

When the print robot 140 prints a customized information guide 90, a transaction message 760 is sent to a message handler 770. The message handler 770 stores the transaction in the service-provider transactions data repository 780 and forwards the message to the data collection machine 700 where the process is repeated. The report generator 790 uses data from the service-provider-transactions data repository 780, and service provider data 545 to generate reports 795. Forwarding the information to the data collection machines provides a back up of the information. Data collection machines may be configured to forward the information to other data collection machines allowing the creation of a hierarchy of machines. Machines higher in the hierarchy contain information of machines lower in the hierarchy and can generate reports about the transactions in machines that are lower in the hierarchy. In addition, the message handler 770 provides an interface to other machines. Those machines may be used to automatically bill the service providers when their content is printed.

The minimum information required to enroll a service provider is the geographical location of the service provider, a question, an answer and a reference to its content on a network such as the Internet or to a manually created formatted content. The question and the answer are used to attach the service provider reference to questionnaires in service hosts. A catalog of questions will be used to select existing questions and answers or, a new question and/or a new answer may be created.

When a service host or a service provider is enrolled, a data collection machine may be specified so that the transactions are sent to that machine. Transactions are stored in the service host until authorization from the data collection machine is given to erase them. When no data collection machine exists, operator authorization is needed to erase the transactions.

Transaction information is used to generate reports of service hosts and service providers'activity. For example, a service host report may include the list of the guest that received information guides, the date when the guides were printed, as well as the number of pages of each guide. A service report may include the list of the guests for which content was printed, the selected content that was printed, the date and time when the guides containing the reports were printed and some profile information.

For a service provider, a data collection machine must be specified. The data collection machine for a service provider may be a service host. This machine will be called the service-provider home machine. In addition to data collection, the machine will provide storage for service-provider content and for the service-provider data repository where the information needed to resolve service provider references is stored.

When a service host is resolving a reference for a service provider, the service provider home machine will be the first one used to solve the reference. If the data collection machine is unavailable, the service host will use its local copy of the service-provider data repository to solve the reference.

In addition to the data collection machine for service providers, one or more service hosts that will print information about the service provider needs to be specified. Every specified service host will receive a message with the URL of service-provider home machine, the question, the subject or subjects of the question, the user profiles for which the question is intended, the answer, and the references.

If there is a reference to a service provider, the service provider information used to solve the service provider reference into content references includes the SGML tags used to determine when a service provider reference is active. The tags are sent along with the message.

Service hosts can be configured to process incoming messages automatically, or to require operator intervention before an incoming message that will modify the content of the service host questionnaire is processed. When the message is processed by a service host, the URL of service-provider home machine is stored in the local service-provider data repository. To include the references to the service providers, a similar question will be looked for in the service host questionnaire. If a similar question is not found, the question may be added to the machine questionnaire, taking into consideration user profile information about the question and type. Once the question is found, a similar answer will be looked for. If a similar answer is not found, the answer may be added to the question. Once the answer is found, the reference will be added to the answer.

The service-provider information contained in the message is added to the service-provider data repository so it can be used to generate local reports and as a back-up in case the service-provider data-repository machine is unavailable.

The geographical location information is used to find the potential service providers for a service host and the potential service hosts for service providers, and to generate a map that indicates the location of the service providers, and by the service-provider report generator, to generate reports.

In a further embodiment of the invention, users may enroll to provide content such as reviews and to take advantage of previously selected questionnaires to generate customized information guides or to pre-select answers in interactive versions of the questionnaire interface module.

In a further embodiment of the invention, the answer list may be sent to other systems subject to privacy laws. For example, the answers may be sent to a travel agency or to the hotel database and forwarded to other hotels every time that the user makes a reservation. When a user arrives to a new location, the questionnaire is automatically answered from the answers selected for previous questionnaires.

SGML tags added to references make it possible for a service provider or service host to specify when a reference is active. References may be active depending on date constrains. For example, a reference may be printed every Monday. A reference may be selected to be active, edited or updated through the use of an interactive interface such as a web browser or an audio-text system, or a reference may be made active using other criteria. For example, a service provider may specify that a reference is active only for brochures 1 to 100 that day, or that a reference is active after 100 brochures have been printed. In the latter case, the SGML tag may call a program that implements the decision algorithm.

In the preferred embodiment of the invention, the information guides are printed upon arrival of the guest, and for longer stays the answers of the user are stored to generate daily guides. The ability that service providers have to select the content that they want to print, together with the timeliness of brochures, allow service providers a degree of flexibility in their promotions similar to that which has been enjoyed by the airline industry for a long time.

In a further embodiment of the invention, the questionnaires filled by the guest are collected and processed in a centralized location and the guides are delivered to the hotels and then distributed to the users.

Additional SGML tags are used to specify the type of content pointed to by the reference. The types of content for the preferred embodiment of the invention are formatted content, HTML content or data content. In the case of formatted content, the tags may specify that the content date should be checked against a URL, and if the content is obsolete, a program can be called to send a message to an operator so that a new version of the content is manually created. In the case of HTML content, the tags may specify whether or not the content date needs to be checked and whether or not the content should be formatted automatically by the HTML-to-formatted-content filter. If the content is to be formatted automatically, additional tags may provide clues that help the HTML-to-formatted-content filter. If the content is data, tags may specify the IP and port needed to get to the content as well as the messages that need to be sent to a server to get to the content or any other information needed to get to the data.

An example of a question is, “What kind of food do you like?” One of the answers may be Mexican food and the service host editor will associate the Mexican restaurants that he wants to recommend to the answer. Questions are classified by subject and user profile information. Examples of subjects are food, entertainment, and cultural information. Examples of user profile information are families with children, retired guests, and executives. The classification is used by the programs that format the questionnaire for printing or for presentation into different interfaces to organize the questions. The classification allows the automatic generation of various types of questionnaires for different types of guests and the hierarchical organization of the questionnaire in interactive interfaces.

To create a questionnaire, it is possible to go to a service host data collection machine and to automatically add all the service providers within a given distance from a service host. To make it easier to find the service host data collection machines, lists of data collection machines are maintained so that all the service host data collection machines can be consulted.

To add a question, the process starts by selecting the content. Content may be Internet content, service-provider content, host-provider content, formatted content and generalized database content.

For Internet content, the URL is specified, SGML tags are added to decide if the content is automatically formatted, and an answer is selected. If the answer does not exist, it is created at this time. When a new answer is created it is attached to a question. If the question does not exist, it is created at this time.

For service-provider and service host content, an enrolled service provider needs to be selected and associated with an answer. If the service provider is not enrolled, it can be enrolled at this time.

When formatted content is created, SGML tags may be added to specify the URL that needs to be checked to decide if content is up-to-date and what to do if it is not. For database content, the protocol and special instructions are specified as SGML tags.

The template file contains SGML tags that describe how to present a questionnaire for different interfaces and how to customize an information guide for a service host. Examples of information contained in the template file are the hotel logo, its position and size, information used to build the cover page of the customized information guide, the address and phone number of the hotel and their positions in the information guide, etc.

Since the questionnaire and templates are text files with SGML tags, text editors may be authoring tools. More sophisticated authoring tools allow authors to manipulate the questionnaire and template files interactively. Other programs may be used to facilitate the creation of templates, for example, HTML generators or graphic creation programs.

Reports are used to generate revenue opportunities, for example, by charging the hotel for every information guide that is printed, and charging the service providers every time that ads are printed. Since the brochures will provide value to guests in the form of information, coupons and discounts, the hotel may charge the user for every printed information guide or for every time that the content is downloaded to a PDA or other device. Report are also used to give information about the printed guides to sponsors and other interested parties.

A further embodiment of the invention allows the creation of super-questionnaires. Super-questionnaires are the union of questionnaires from more than one service host. When a user answers a super-questionnaire, an answer list is provided for each service host and sent to the host to produce a print list. The print lists are merged and sent to an instance of the layout software that produces the questionnaire. Using a super-questionnaire, a job applicant answers questions about his job preferences and the questionnaires are sent to the host servers of all the potential employers. The combined information from all the companies is used to produce a single employment information guide.

One embodiment of the invention describes how to use the collaborative creation of customized content to generate customized information guides. It is understood by those versed in the art that farther embodiments of the invention can be used to create customized content in any application that allows the information to be organized in a questionnaire. Even when the questionnaire is not printed as is the case of information about products where the questions are implicitly answered by scanned products bar codes. Examples of this kind of applications are, shopping information guides, where a shopper answers a questionnaire about the items that he or she is interested in and the system produces a guide with information about the merchandize and a map showing the stores and the departments within the stores where the items can be found; a guide that provides instruction on how to use products in a store; a questionnaire used in a hospital that may be used by patients or family members to find more information about their health problems or about services available at a medical center or hospital; a recruiting super-questionnaire may be answered by job applicants to find potential companies and descriptions of the jobs available.

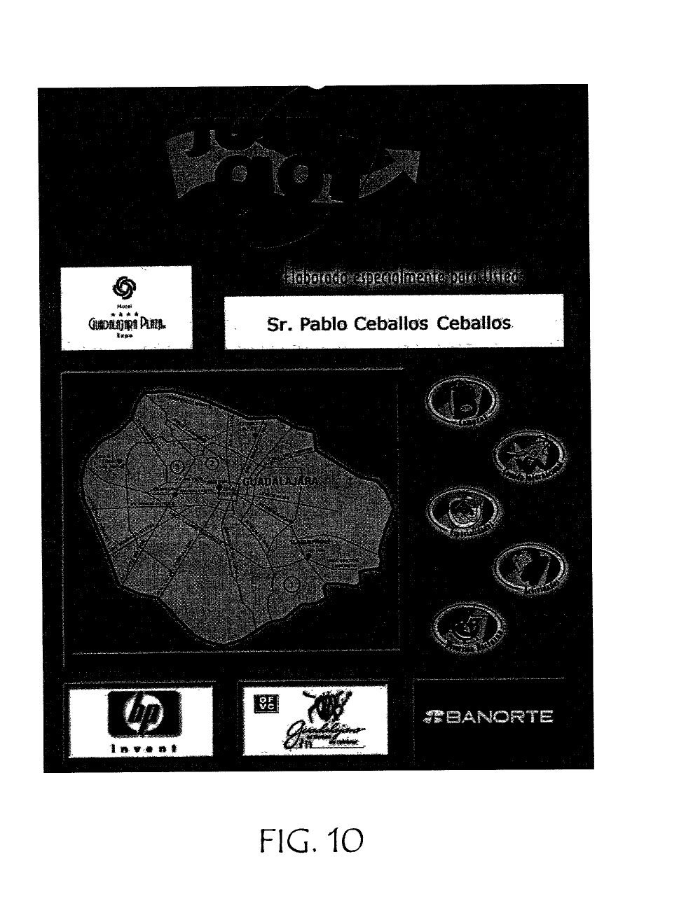

FIG. 10 illustrates the cover of an exemplary customized tour guide. The cover includes a map that identifies the locations of various service providers. Each service provider locations is designated by a number on the map, e.g., “1”, “2”, “3”. It is to be appreciated that other designations can be used.

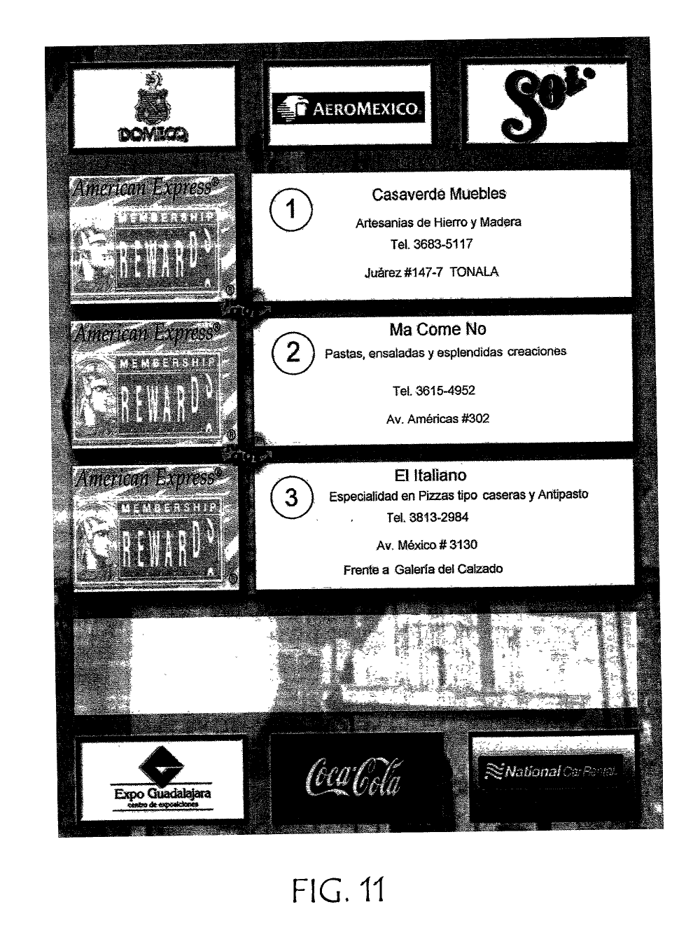

FIG. 11 illustrates the first page of the tour guide of FIG. 10. The first page lists various exemplary service providers, e.g., “Casaverde Muebles.” The reference number on the map is printed near or on the advertisement containing the address and contact information for the service provider.

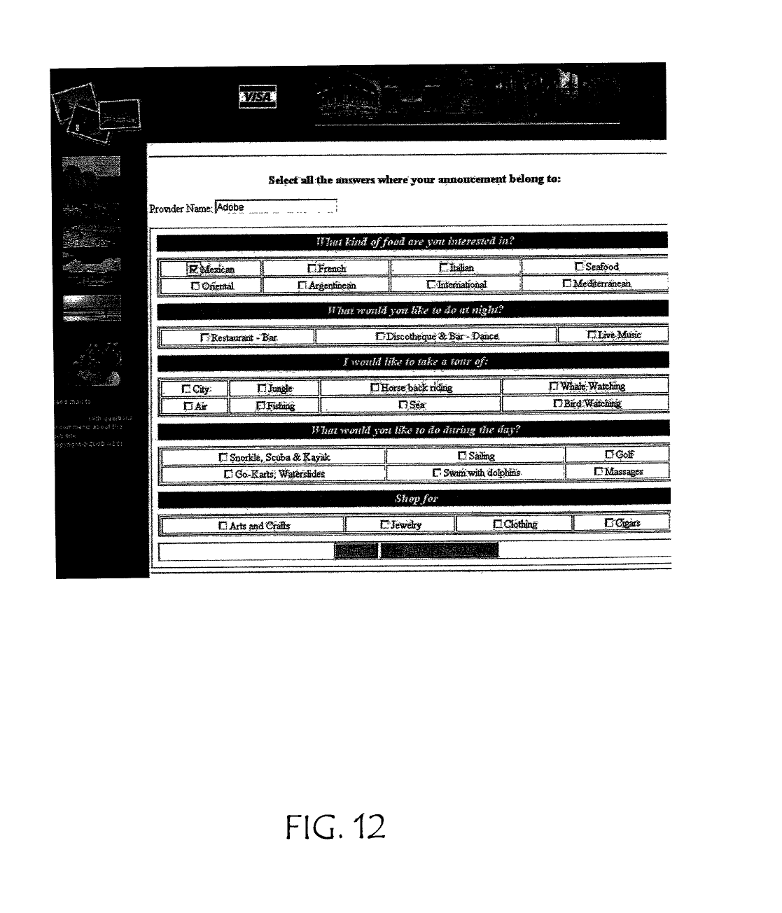

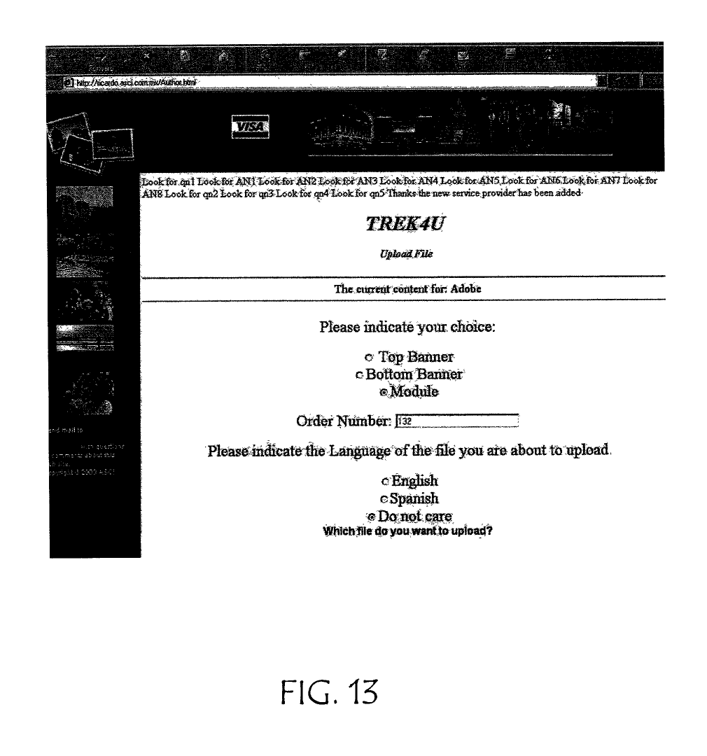

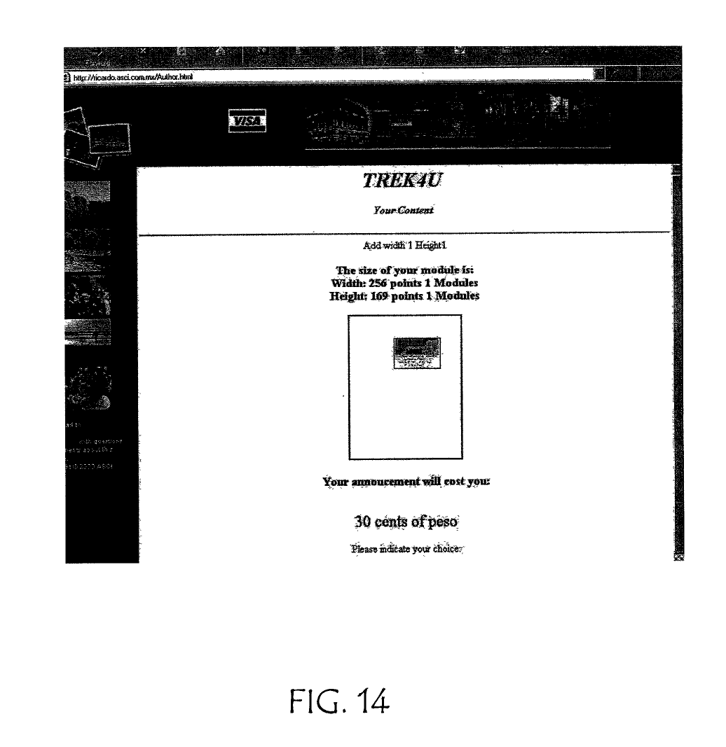

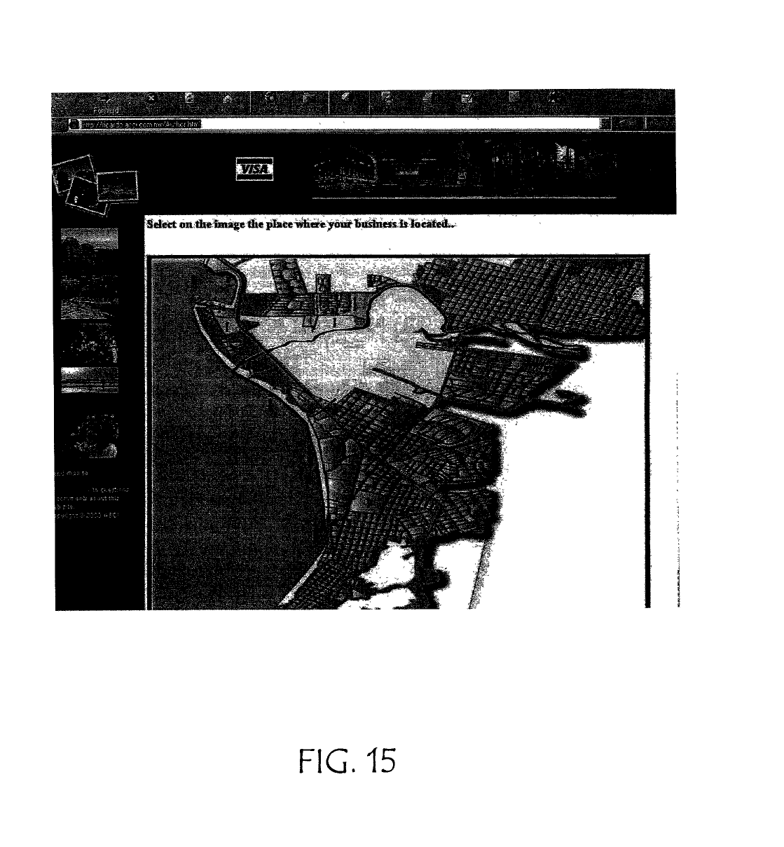

FIG. 12-15 each illustrate certain graphic interfaces that may be used by a service provider to upload advertisements and other content for inclusion the customized tour guide. Depending on the embodiment, other interfaces may be added, and selected interfaces may be deleted and/or modified. In one embodiment of the invention, the graphic interfaces are web pages that are accessible via the Internet from any remote location connected to the Internet. FIG. 12 illustrates a graphic interface whereby the service provider can associate answers to the service providers goods and services. For example, shown in FIG. 12, the provider “Adobe”, a Mexican food restaurant, has identified that their services are associated with providing Mexican Food. Thus, when users answer a questionnaire and indicate that they like Mexican Food, advertisement for Adobe would be a likely candidate for inclusion in the customized tour guide. FIG. 13 illustrates a graphic interface that may be used for a service provider to upload advertisements. FIG. 14 illustrates an exemplary confirmation screen. FIG. 15 illustrates a graphic interface wherewith the service provider can indicate where the service provider's services and/or goods are located. When the customized tour guide is created with one of the service provider's advertisements, the system marks on a map in the customized tour guide the location that was indicated by service provider.

The invention may be embodied in other specific forms without departing from its spirit or essential characteristics. The described embodiments are to be considered in all respects only as illustrative and not restrictive. The scope of the invention is indicated by the appended claims rather than by the foregoing description. All changes and variations which come within the meaning and range of equivalency of the claims are to be embraced within their scope.

What is claimed is:

1. A method of producing customized information documents, the method comprising:
recording a plurality of user preferences;
retrieving service provider information that is associated with a service host, a location, or a subject;
identifying a portion of the information that relates to the user preferences;
creating a custom information document using the identified portion of the service provider information; and
outputting the custom information document.

2. The method of claim 1, wherein the user preferences are determined from the results of a questionnaire that includes a plurality of questions.

3. The method of claim 2, wherein the questions are classified by subject.

4. The method of claim 1, wherein information about the geographical location of service providers and service hosts is retrieved and used to determine location relevance.

5. The method of claim 4, wherein the service provider information includes a geographic location of a service provider, and wherein the geographic location is used to generate a mark on a map indicating the position of the service provider.

6. The method of claim 1, wherein the service provider information that is to be retrieved from one or more sets of information is specified by a service provider.

7. The method of claim 6, wherein the service provider specifies the information set that is to be retrieved based on a time constraint.

8. The method of claim 6, wherein the service provider specifies the information set that is to be retrieved based on the number of custom information documents that have been created and that include the service provider information.

9. The method of claim 6, wherein the service provider interactively edits or selects the service provider information that is to be retrieved concurrently with the creating of the custom information document.

10. The method of claim 1, wherein a template is used to generate the layout of the custom information document.

11. The method of claim 1, wherein recording user preferences includes formatting a questionnaire-based user interface comprising questions and answers.

12. The method of claim 11, wherein the questionnaire-based user interface comprises a program that formats and prints questionnaires, wherein a user answers the questionnaires with a pen or pencil, and wherein the questionnaires are scanned and processed by the program to determine user preferences.

13. The method of claim 12, wherein handwritten information on the questionnaire is stored by the program.

14. The method of claim 11, wherein different questionnaires are printed according to different user profiles.

15. The method of claim 11, wherein the questionnaire is formatted to produce an Hypertext Markup Language interface and the user answers the questionnaire using a web browser to record user preferences.

16. The method of claim 11, wherein the questionnaire is formatted by a program to produce an Hypertext Markup Language interface suitable for television display and the user answers the questionnaire using the remote control of the television to record user preferences.

17. The method of claim 11, wherein the questionnaire is formatted by a program to produce a file that is then used by an audio-text system to prompt the user with voice messages and the questionnaire is answered through the telephone.

18. The method of claim 11, wherein the questionnaire is formatted to produce a file that is downloaded to a personal display adapter or any other portable computer device which is then used to answer the questionnaire to record user preferences.

19. The method of claim 1, wherein user preferences are identified based at least in part upon user preference information that is associated with a credit card.

20. The method of claim 19, wherein user preferences are obtained from a database using identification information from the credit card.

21. The method of claim 20, wherein the database contains an answer list previously completed by the user.

22. The method of claim 19, wherein user preferences are stored on the credit card.

23. The method of claim 1, wherein retrieving service provider information includes retrieving service provider information available on the Internet or in general databases to enhance the content of the customized information document.

24. The method of claim 1, wherein recording user preferences includes retrieving previously recorded user preferences to generate customized content when the user visits other service hosts.

25. The method of claim 1, wherein identifying a portion of the service provider information includes statistically analyzing the most popular service providers that are selected by users with similar profiles.

26. The method of claim 1, wherein a service provider receives reports on the number of times the corresponding service provider information has been included in a plurality of custom information documents.

27. The method of claim 1, wherein a service provider specifies in the custom information document which service provider information is retrievable for inclusion in the custom information document.

28. The method of claim 1, further comprising retrieving reviews of service providers and service hosts from users who have received an information guide.

29. A method providing formatted service provider information, comprising:
generating a questionnaire with a plurality of questions, with each question having one or more potential answers;
associating at least one reference to service provider information with each potential answer;
receiving answers to the questionnaire;
generating an answer list comprising the associated references to the received answers;
retrieving service provider information for at least one of the references in the answer list;
formatting the service provider information in a layout suitable for printing or viewing; and
outputting the formatted service provider information to an output device.

30. The method of claim 29, wherein information about the geographical location of service hosts and service providers is retrieved and is used to determine location relevance.

31. The method of claim 29, wherein the service provider information includes the geographical location of a service provider and therefor the geographic location is used to generate a mark on a map indicating the position of the service on the map.

32. The method of claim 29, wherein the service provider specifies the information to be retrieved from one or more sets of information.

33. The method of claim 32, wherein the service provider specifies the information set to be retrieved based on a time constraint.

34. The method of claim 33, wherein the service provider specifies the information set to be retrieved based on the number of information guides that have been created during a selected time interval and that incorporate the service provider information.

35. The method of claim 33, wherein the service provider can interactively edit or select the service provider information that is to be retrieved.

36. The method of claim 29, wherein the user answers the questionnaire with a pen or pencil, and the questionnaire is scanned and processed by a program to determine answers.

37. The method of claim 29, wherein handwritten information on the questionnaire is stored by the program.

38. The method of claim 29, wherein different questionnaires are printed for different user profiles.

39. The method of claim 29, wherein user answers the questionnaire using a web browser to record user answers.

40. The method of claim 29, wherein the user answers the questionnaire using the remote control of the television to record user preferences.

41. The method of claim 29, wherein the user answers the questionnaire with voice messages and the questionnaire is answered through the telephone.

42. The method of claim 29, wherein the questionnaire is formatted by a program to produce a file that is downloaded to a personal display adapter or any other portable computer device and the device is then used to answer the questionnaire to record user preferences.

43. The method of claim 29, further comprising associating answer list information with a credit card.

44. The method of claim 43, wherein the answer list is stored in a database and obtained at least in part from the database using the answer list information from the credit card.

45. The method of claim 44, wherein the database contains an answer list previously completed by the user.

46. The method of claim 29, wherein the user answer list is stored on a credit card.

47. The method of claim 29, further comprising retrieving information available on the Internet or in general databases for inclusion in the formatted service provider information.

48. The method of claim 29, further comprising retrieving previously recorded answer lists to generate the answer list.

49. The method of claim 29, further comprising retrieving reviews of service providers and service hosts from other users who have received an information guide, wherein the retrieved reviews are using at least in part to generate at least one of the answers.

50. A system to produce customized information documents, comprising:
means for storing service provider information that describes one or more aspects of a service provider;
means for inputting a set of user preferences;
means for associating selecting information content, wherein the information content that is selected is based at least in part upon the input user preferences;
means for storing layout information;
means for formatting the selected information content with the layout information in the form of a guide suitable for printing or viewing in a plurality of media; and
means for outputting the guide to an output device.

51. The method of claim 50, wherein the user answers the questionnaire by scanning bar codes printed on products.

52. The method of claim 50, wherein the user answers the questionnaire by scanning bar codes printed in cards designed for such a propose.

53. The method of claim 50, wherein the guide is a travel guide.

54. The method of claim 50, wherein the information content relates to travel attractions.

55. A program storage device storing instructions that when executed perform the method comprising:
recording a plurality of user preferences;
retrieving service provider information that is associated with a service host, a location, or a subject;
identifying a portion of the information that relates to the user preferences;
creating a custom information document using the identified portion of the service provider information; and
outputting the custom information document.
